(19) United States
(12) Patent Application Publication
(10) Pub. No.: US 2020/0267684 A1
(43) Pub. Date: Aug. 20, 2020

(54) RSRP Reporting Methods for NR High Resolution Angle-based Downlink Positioning

(71) Applicant: MEDIATEK INC., Hsin-Chu (TW)

(72) Inventors: Xuan-Chao Huang, Hsin-Chu (TW); Chiao Yao Chuang, Hsin-Chu (TW)

(21) Appl. No.: 16/790,915

(22) Filed: Feb. 14, 2020

Related U.S. Application Data
(60) Provisional application No. 62/806,028, filed on Feb. 15, 2019.
(60) Provisional application No. 62/826,094, filed on Mar. 29, 2019.
(60) Provisional application No. 62/828,565, filed on Apr. 3, 2019.
(60) Provisional application No. 62/842,630, filed on May 3, 2019.

(51) Int. Cl. H04W 64/00; H04L 5/00; H04W 24/10; H04B 17/318; H04W 16/28; H04B 7/08

(52) U.S. Cl. CPC H04W 64/003; H04L 5/0051; H04B 7/086; H04B 17/318; H04W 16/28; H04W 24/10

(57) ABSTRACT

A method of reference signal received power (RSRP) reporting for New Radio (NR) high resolution angle-based downlink positioning is proposed. UE measures positioning reference signal (PRS) resource sets by performing beam sweeping for a coarse direction search, and then fixes RX beam for RSRP measurements. UE derives RSRP measurement results for each PRS resource set, which comprises multiple PRS resources. UE reports RSRP measurement results of a portion of PRS resource sets. The reported RSRP measurement results comprise an RSRP ratio or a differential RSRP with respect to a highest RSRP value of a PRS resource in a reported PRS resource set.

### CROSS REFERENCE TO RELATED APPLICATIONS

This application claims priority under 35 U.S.C. § 119 from U.S. Provisional Application No. 62/806,028 entitled “Invention on RSRP Reporting Methods for NR High Resolution Angle-Based Downlink Positioning,” filed on Feb. 15, 2019; U.S. Provisional Application No. 62/826,094 entitled “Invention on UE Measurement and Reporting Methods for NR High Resolution Angle-Based Downlink Positioning,” filed on Mar. 29, 2019; U.S. Provisional Application No. 62/828,565 entitled “Invention on UE Measurement with Multiple Rx Antenna Panels for NR High Resolution Angle-Based Downlink Positioning,” filed on Apr. 3, 2019; U.S. Provisional Application No. 62/842,630 entitled “Invention on UE Measurement and Reporting Methods for NR High Resolution Angle-Based Downlink Positioning—Refinements & Extensions,” filed on May 3, 2019—the subject matter of which is incorporated herein by reference.

### TECHNICAL FIELD

The disclosed embodiments relate generally to wireless communications system, and, more particularly, to measurement and reporting methods for downlink positioning in NR mobile communication networks.

### BACKGROUND

Third generation partnership project (3GPP) and Long-Term Evolution (LTE) mobile telecommunication systems provide high data rate, lower latency and improved system performances. In 3GPP LTE networks, an evolved universal terrestrial radio access network (E-UTRAN) includes a plurality of base stations, e.g., evolved Node-Bs (eNBs) communicating with a plurality of mobile stations referred as user equipment (UEs). Enhancements to LTE systems are considered so that they can meet or exceed IMA-Advanced fourth generation (4G) standard. The Next Generation Mobile Network (NGMN) board, has decided to focus the future NGMN activities on end-to-end requirements for 5G new radio (NR) systems. In 5G NR systems, the base stations are referred to as gNBs.

Direction fining (DF) positioning is achieved from either Angle of Departure (AoD) or Angle or Arrival (AoA). In AoD, the transmitter transmits through multiple antennas and the receiver resolves the angle of departure relative to the antenna platform of the transmitter based on the received signals. In AoA, the receiver employs multiple antennas to receive signal and resolves angle of arrival relative to its own antenna platform orientation. In NR networks, downlink (DL) angle-based positioning is achieved from AoD, which is the angle along which gNB transmits positioning reference signal (PRS) to UE (AoD may include azimuth angle and zenith angle). DL-AoD positioning can help to position a UE when GNSS signal is not available to that UE. DL-AoD positioning does not require gNBs to be highly synchronized as UE does not need to measure TDOAs (time different of arrivals).

During a high-resolution DL-AoD positioning procedure, 1) the network configures an UE to measure PRS power for several transmission/reception points (TRPs); 2) each TRP transmits PRS with multiple beams; 3) the UE measures PRS beams transmitted from TRPs and reports RSRP measurement results of beams to the network; 4) the network estimates the AoDs based on the UE's RSRP report; and 5) a location server estimates the UE's position by using the estimated AoDs. Accordingly, a procedure for UE to perform measurements for PRS beams needs to be defined. In addition, a method for reporting the RSRP measurement results is desired with reduced reporting overhead and unified reporting format.

### SUMMARY

A method of reference signal received power (RSRP) reporting for New Radio (NR) high resolution angle-based downlink positioning is proposed. UE measures positioning reference signal (PRS) resource sets by performing beam sweeping for a coarse direction search, and then fixes RX beam for RSRP measurements. UE derives RSRP measurement results for each PRS resource set, which comprises multiple PRS resources. UE reports RSRP measurement results of a portion of PRS resource sets. The reported RSRP measurement results comprise an RSRP ratio or a differential RSRP with respect to a highest RSRP value of a PRS resource in a reported PRS resource set.

In one embodiment, a UE receives configuration information in a communication network, wherein the configuration information comprises multiple positioning reference signal (PRS) resource sets for UE measurements and reporting. Each PRS resource set comprises multiple PRS resources of a transmission/reception point (TRP) and each PRS resource has a PRS resource ID and is associated with a beam of the TRP. The UE determines reference signal received power (RSRP) measurement results of the configured PRS resource sets by performing measurements on PRSs over the configured PRS resource sets transmitted from multiple TRPs. The UE reports RSRP measurement results of a portion of PRS resource sets. The reported RSRP measurement results comprise an RSRP ratio or a differential RSRP with respect to a highest RSRP value of a PRS resource in a reported PRS resource set.

Other embodiments and advantages are described in the detailed description below. This summary does not purport to define the invention. The invention is defined by the claims.

### BRIEF DESCRIPTION OF THE DRAWINGS

FIG. 1 illustrates a high-resolution downlink angle of departure (DL-AoD) positioning procedure in a new radio (NR) mobile communication network in accordance with one novel aspect.

FIG. 2 is a simplified bock diagram of a base station/location server and a UE that carry out certain embodiments of the invention.

FIG. 3 illustrates a method of UE performing measurements and reporting for DL-AoD positioning procedure in accordance with one novel aspect.

FIG. 4 illustrates the concept of positioning reference signal (PRS) resource, PRS resource set, and PRS resource ID.

FIG. 5 illustrates the definition of maximum PRS RSRP and average PRS RSRP.

FIG. 6 illustrates examples of down-selecting a portion of PRS resource sets.

FIG. 7 illustrates examples of down-selecting PRS resources from a PRS resource set.

FIG. 8 illustrates examples of reporting RSRP measurement results with reduced reporting overhead in accordance with one novel aspect.

FIG. 9 illustrates a detailed procedure of UE performing measurements and reporting for DL-AoD positioning in accordance with one novel aspect.

FIG. 10 is a flow chart of the method of RSRP reporting for DL-AoD positioning in accordance with one novel aspect.

### DETAILED DESCRIPTION

Reference will now be made in detail to some embodiments of the invention, examples of which are illustrated in the accompanying drawings.

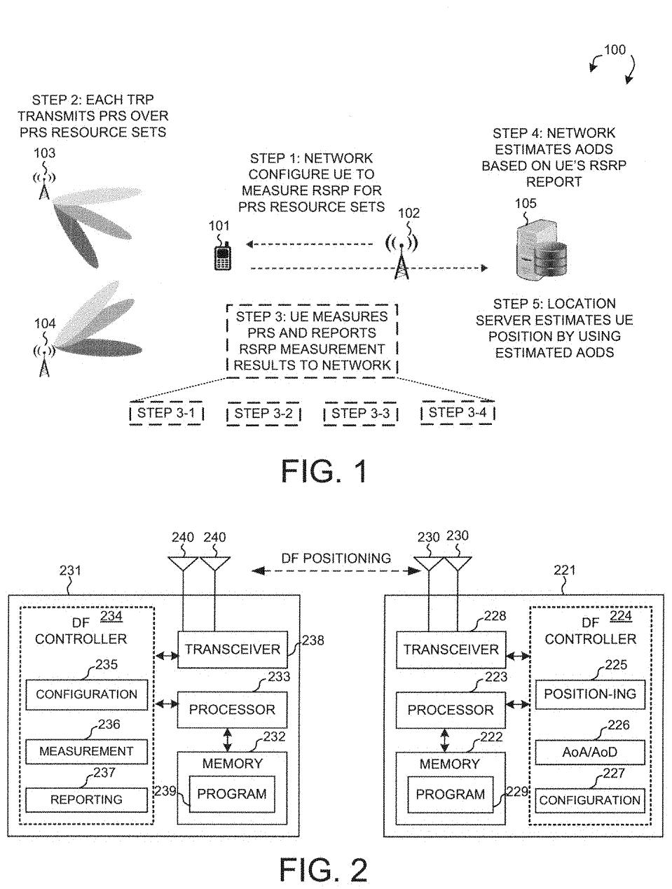

FIG. 1 illustrates a high-resolution downlink angle of departure (DL-AoD) positioning procedure in a new radio (NR) mobile communication network 100 in accordance with one novel aspect. NR mobile communication network 100 comprises a user equipment UE 101, a plurality of base stations gNB 102-104, and a location server 105. In NR networks, downlink (DL) angle-based positioning is achieved from angle of departure (AoD), which is the angle along which gNB transmits a positioning reference signal (PRS) to UE (AoD may include azimuth angle and zenith angle). DL-AoD positioning can help to position a UE when GNSS signal is not available to that UE. DL-AoD positioning does not require gNBs to be highly synchronized as UE does not need to measure TDOAs (time different of arrivals). As depicted in FIG. 1, there are five steps in a high-resolution DL-AoD positioning procedure. Step-1: the network (e.g., serving gNB 102 configures UE 101 to measure RSPS for PRS resource sets of several transmission/reception points (TRPs); Step-2: each TRP transmits PRS over PRS resource sets; Step-3: UE 101 measures PRS transmitted from TRPs and reports RSRP measurement results to gNB 102; Step-4: gNB 104 estimates the AoDs based on the UE's RSRP report; and Step-5: location server 105 estimates the UE's position by using the estimated AoDs.

A procedure for UE 101 to perform measurements for PRS resource sets needs to be defined. In addition, a method for reporting the RSRP measurement results is desired with reduced reporting overhead and unified reporting format. In accordance with one novel aspect, a four-step method of PRS measurements and RSRP reporting is proposed. In step 3-1, UE measures PRS resource sets by performing beam sweeping for a coarse direction search, and then fixes RX beam for RSRP/TOA measurements. In step 3-2, UE determines the maximum or average PRS RSRP for each PRS resource set, and then down selects a portion of PRS resource sets based on the maximum or average PRS RSRP. In step 3-3, for a selected PRS resource set, UE down selects a portion of PRS resources from all PRS resources of the PRS resource set. In step 3-4, for a selected PRS resource set and the corresponding selected PRS resources, UE reports RSRP ratios or differential RSRPs derived from the RSRP measurement results to the network. Note that the steps of down select PRS resource sets and PRS resources are optional and can be skipped. In other words, UE can report RSRP measurement results for all PRS resource sets and for all PRS resources of each of the reported PRS resource sets.

FIG. 2 is a simplified bock diagram of a base station/location server 221 and a UE 231 that carry out certain embodiment of the invention. Network device 221 comprises memory 222, a processor 223, a positioning controller 224, which further comprises a positioning module 225, an AoA/AoD module 226, and a configuration module 227, and a transceiver 228 coupled to multiple antennas 230. Similarly, UE 231 comprises memory 232, a processor 233, a positioning controller 234, which further comprises a configuration module 235, a measurement module 236, a measurement reporting module 237, and a transceiver 238 coupled to multiple antennas 240.

For network device 221, antennae transmit antennae 230 receive radio signal. RF transceiver module 228, coupled with the antennae, receives RF signals from the antennae, converts them to baseband signals and sends them to processor 223. RF transceiver 228 also converts received baseband signals from the processor, converts them to RF signals, and sends out to antennae 230. Processor 223 processes received baseband signals and invokes different functional modules and circuits to perform features in wireless device 221. Memory 222 stores program instructions and data 229 to control the operations of device 221. Similarly, for UE 231, antennae 240 transmit and receive RF signals. RF transceiver module 238, coupled with the antennae, receives RF signals from the antennae, converts them to baseband signals and sends them to processor 233. RF transceiver 238 also converts received baseband signals from the processor, converts them to RF signals, and sends out to antennae 240. Processor 233 processes received baseband signals and invokes different functional modules and circuits to perform features in UE 231. Memory 232 stores program instructions and data 239 to control the operations of UE 231.

The different modules are functional circuits that can be implemented and configured in software, firmware, hardware, and any combination thereof. The functional modules, when executed by processors 223 and 233 (via program instructions 229 and 239 contained in memory 222 and 232), interwork with each other to allow the network device to perform AoA/AoD positioning for UE. Each functional circuit may be implemented using a processor and corresponding program instructions. For example, the measurement module performs PRS measurements, the reporting module reports RSRP measurement results, the AoD/AoA module estimates AoD/AoA, and the positioning module estimates the location of the UE based on the AoD/AoA estimations, and the configuration circuits configure PRS resource sets and AoD/AoA related parameters and controls the different modules for corresponding positioning procedures. Note that the AoD/AoA and positioning estimation can be done either by a base station or by a location server.

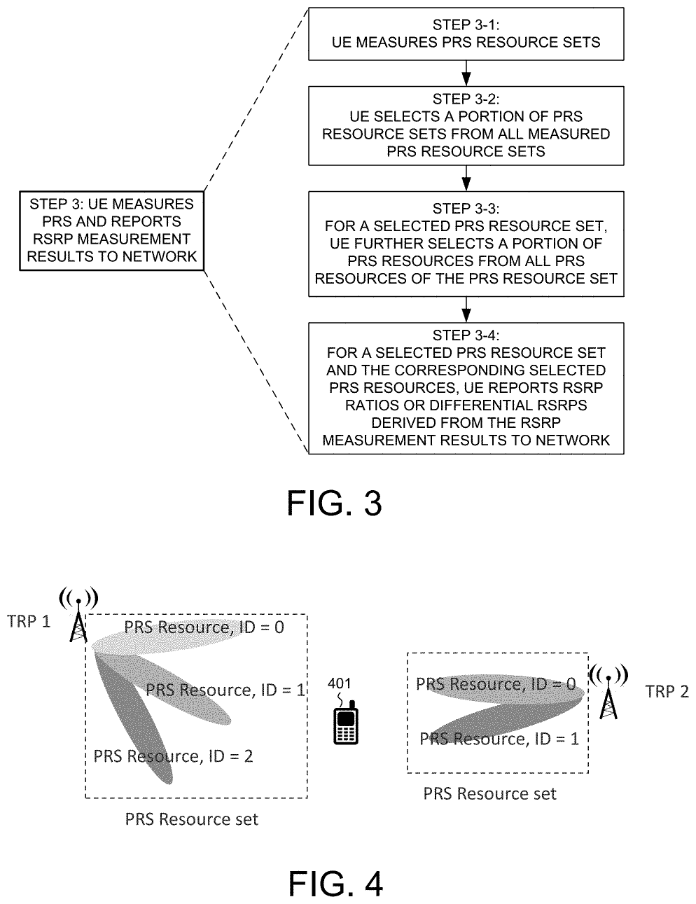

FIG. 3 illustrates a method of UE performing measurements and reporting for DL-AoD positioning procedure in accordance with one novel aspect. In step 3-1, UE measures PRS resource sets by performing beam sweeping for a coarse direction search, and then fixes RX beam for RSRP/TOA measurements. In step 3-2, UE determines the maximum or average PRS RSRP for each PRS resource set, and then down selects a portion of PRS resource sets based on the maximum or average PRS RSRP. In step 3-3, for a selected PRS resource set, UE down selects a portion of PRS resources from all PRS resources of the PRS resource set. In step 3-4, for a selected PRS resource set and the corresponding selected PRS resources, UE reports RSRP ratios or differential RSRPs derived from the RSRP measurement results to the network. Note that the steps of down select PRS resource sets and PRS resources are optional and can be skipped. In other words, UE does not need to do any “selection”, UE can simply report RSRP measurement results for all configured PRS resource sets and for all PRS resources of each of the reported PRS resource sets.

FIG. 4 illustrates the concept of positioning reference signal (PRS) resource, PRS resource set, and PRS resource ID. Via radio resource control (RRC) signaling, a serving base station provides configuration information of PRS resource sets to UE 401 for the purpose of DL-AoD positioning. PRS refers to a positioning reference signal. PRS is transmitted by a TRP, and UE 401 is expected to measure the arrival time and/or signal power of the transmitted PRS in order to estimate the location of UE 401. PRS resource specifies the time and frequency resources on which a certain TRP transmits PRS. A PRS resource has a PRS resource ID. A PRS resource ID is associated with a single beam transmitted from a single TRP. PRS resource set is a set of PRS resources. The PRS resources in a PRS resource set are associated with the same TRP. In the example of FIG. 4, TRP 1 is associated with a PRS resource set, which consists of 3 PRS resources, each PRS resource has a PRS resource ID, and each PRS resource ID is associated with a beam. Similarly, TRP 2 is associated with another PRS resource set, which consists of 2 PRS resources, each PRS resource has a PRS resource ID, and each PRS resource ID is associated with a beam. Note that Multiple PRS resource sets from different TRPs need to be configured for DL AoD positioning, and a TRP may be replaced by a cell.

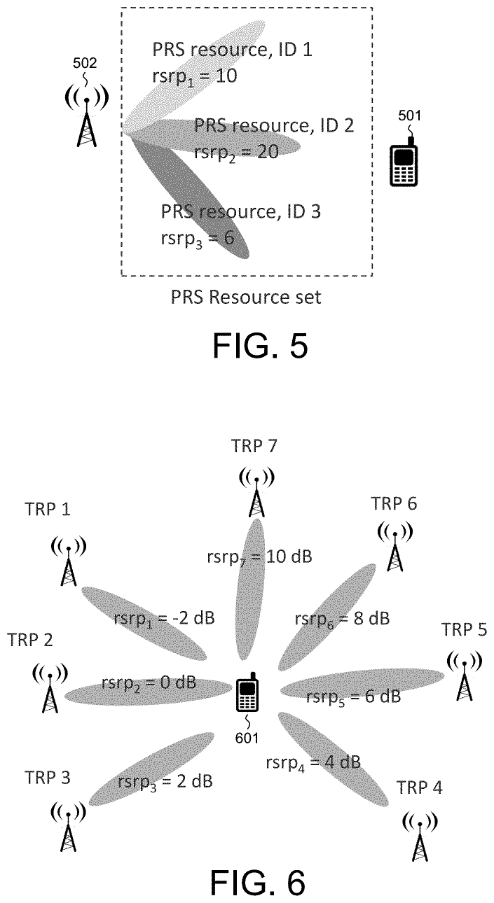

FIG. 5 illustrates the definition of maximum PRS RSRP and average PRS RSRP for the purpose of performing PRS measurements and deriving RSRP measurement results. For a PRS resource set, the “maximum PRS RSRP” is defined as the largest RSRP among all RSRPs measured from PRS resources of that PRS resource set. For a PRS resource set, the “average PRS RSRP” is defined as an average of RSRPs over all or a portion of RSRPs measured from PRS resources of that PRS resource set. In the example of FIG. 5, gNB 502 is associated with a PRS resource set, which consists of 3 PRS resources having resource ID 1, 2, 3, respectively. UE 501 performs RSRP measurements on the 3 PRS resources, and the RSRPs measured from the 3 PRS resources are rsrp1=10 dB, rsrp2=20 dB, and rsrp3=6 dB. As a result, the maximum PRS RSRP is rsrp2=20 dB. The average PRS RSRP may be (rsrp1+rsrp2+rsrp3)/3=12 dB, or the average PRS RSRP may be (rsrp1+rsrp2)/2=15 dB.

FIG. 6 illustrates examples of down-selecting a portion of PRS resource sets. Suppose the network configures a UE to measure PRS RSRP for N PRS resource sets, it is feasible for the UE to select a portion of PRS resource sets from the N configured PRS resource sets. In one example, UE selects k PRS resource sets based on the maximum PRS RSRPs derived from measured PRS resource sets. As depicted in FIG. 6, suppose the network configures UE 601 to measure N=7 PRS resource sets, and PRS resource set with ID j is associated with TRP j for j=1, 2, . . . 7. Suppose the maximum PRS RSRP UE measured for the 7 PRS resource sets are rsrp1=−2 dB, rsrp2=0 dB, rsrp3=2 dB, rsrp4=4 dB, rsrp5=6 dB, rsrp6=8 dB, rsrp7=10 dB. Suppose k=4, then UE 601 selects the 4 best PRS resource sets, namely the PRS resource sets with ID 4, 5, 6, 7. In another example, UE selects k PRS resource sets based on the average PRS RSRPs derived from measured PRS resource sets. For example, UE 601 selects k PRS resource sets such that the average PRS RSRPs measured from the k selected PRS resource sets are larger than the average PRS RSRPs measured from other unselected PRS resource sets.

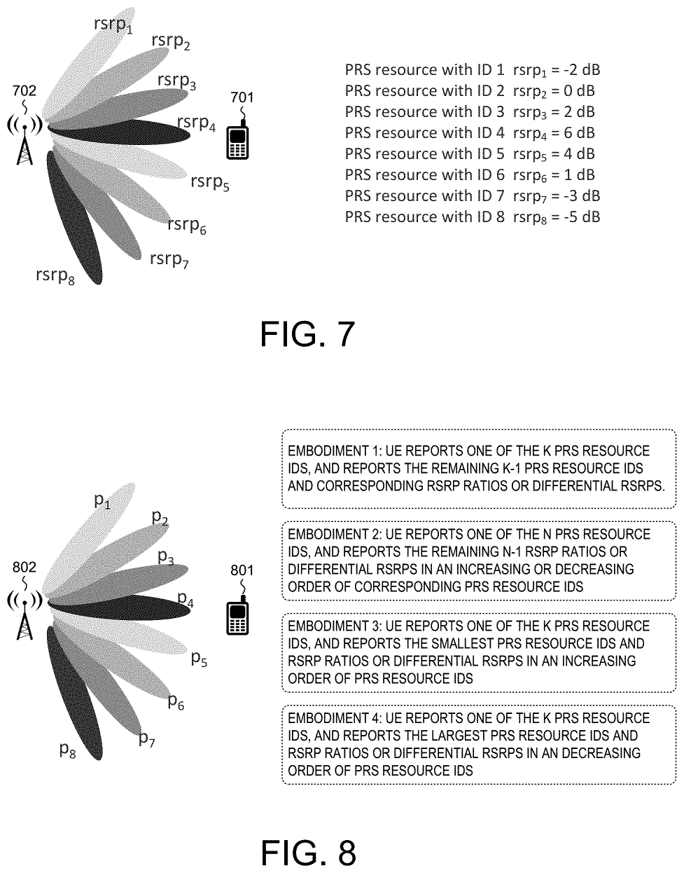

FIG. 7 illustrates examples of down-selecting PRS resources from a PRS resource set. Suppose the network configures a UE to measure PRS RSRP on N PRS resources of a PRS resource set, it is feasible for the UE to select a portion of PRS resources from the N configured PRS resources. In a first method, UE selects k PRS resources such that the RSRPs measured from the selected k PRS resources are larger than that measured from the other unselected PRS resources. In addition, UE selects k PRS resources such that the PRS resource with maximum measured RSRP is included, and the beam corresponding to the k selected resources are contiguous in spatial domain. As depicted in FIG. 7, suppose the network configures UE 701 to measure PRS on N=8 PRS resources of a PRS resource set from gNB 702, each PRS resource is associated with a beam. Suppose that the RSRPs UE measured from the 8 PRS resources are: PRS resource with ID1→rsrp₁=−2 dB, PRS resource with ID2→rsrp₂=0 dB, PRS resource with ID3→rsrp₃=2 dB, PRS resource with ID4→rsrp₄=6 dB, PRS resource with ID5→rsrp₅=4 dB, PRS resource with ID6→rsrp₁₆=1 dB, PRS resource with ID7→rsrp₇=−3 dB, PRS resource with ID8→rsrp₈=−5 dB. Suppose k=4, then UE 701 selects PRS resource ID 3, 4, 5, 6 having larger RSRPs.

FIG. 8 illustrates embodiments of reporting RSRP measurement results with reduced reporting overhead in accordance with one novel aspect. Consider a PRS resource set consisting of N PRS resources. Assume the PRS resource IDs are 1, 2, . . . N without loss of generality. Suppose a UE has selected k PRS resources from the PRS resource set, and UE is going to report RSRPs measured from the k PRS resources to the network. Let pᵢ be the RSRP measured from PRS resource ID i. In the example of FIG. 8, suppose gNB 802 is associated with a PRS resource set consisting of 8 PRS resources, and each PRS resource is associated with a Tx beam. Suppose UE 801 is configured to measure PRS from the N=8 PRS resources of the PRS resource set. Let pᵢ be the RSRP measured by UE 801 for PRS resource with ID i, where i=1, 2, . . . 8. Suppose (p₁, p₂, . . . , p₈)=(−2, 0, 2, 6, 4, 1, −1, −3). There are four embodiments for the UE to report one PRS resource ID and report RSRP ratios or differential RSRPs for the remaining PRS resources with respect to the reported PRS resource ID.

In a first embodiment, UE reports one of the k PRS resource IDs, and then reports the remaining k−1 PRS resource IDs and corresponding RSRP ratios or differential RSRPs for each of the remaining k−1 PRS resources, respectively. Specifically, The UE reports one of the k PRS resource IDs, say it is ID m (i.e., UE reports PRS resource ID m). UE may or may not report pₘ. For PRS resource with ID j, where j≠m, the UE reports j and xⱼ to the network, where

$${x}_{j} = \frac{{p}_{j}}{{p}_{m}} ,$$

or xⱼ=10 log pⱼ−10 log pₘ. Note that 1)

$$\frac{{p}_{j}}{{p}_{m}}$$

corresponds to RSRP ratio, where pⱼ,pₘ are in linear scale, and 2) 10 log pⱼ−10 log pₘ corresponds to differential RSRP in dB scale. As depicted in FIG. 8, under this embodiment, PRS resource ID with m=4 has the highest RSRP (p₄=6). Suppose UE has selected k=3 PRS resources with ID 3, 4, 5, and UE is going to report RSRPs measured from the k=3 selected PRS resources to the network. UE 801 may report the following information to the network: 1) PRS resource ID m=4 (with or without p₄) is reported; and 2)

$$( j , \frac{{p}_{j}}{{p}_{m}} )$$

for j=3,5 is reported to the network, namely, (3, 2/6) and (5, 4/6) is reported to the network. Note that this reporting method works for both k<N and k=N.

In a second embodiment (for this case k=N), UE reports one of the k PRS resource IDs, say it is ID m (i.e., UE reports PRS resource ID m). UE may or may not report pₘ. For PRS resource with ID j, where j≠m, the UE reports xⱼ to the network, where

$${x}_{j} = \frac{{p}_{j}}{{p}_{m}}$$

or xⱼ=10 log pⱼ−10 log pₘ, and the UE does not report the PRS resource ID j to the network. Note that 1)

$$\frac{{p}_{j}}{{p}_{m}}$$

corresponds to RSRP ratio, where pⱼ,pₘ are in linear scale, and 2) 10 log pⱼ−10 log pₘ corresponds to differential RSRP in dB scale. The RSRP ratios or differential RSRPs are reported to the network in an increasing or decreasing order of PRS resource IDs, i.e., in the order of (x₁, x₂, . . . , x_{N}) or (x_{N}, x_{N-1}, . . . , x₁). This can be implemented by using transmission time order or data order in the data packet(s). As depicted in FIG. 8, under this embodiment, PRS resource ID with m=4 has the highest RSRP (p₄=6). Suppose UE has selected k=N=8 PRS resources with ID 1, 2, . . . , 8, and UE is going to report RSRPs measured from the k=N=8 selected PRS resources to the network. UE 801 may report the following information to the network: PRS resource ID m=4 (with or without p₄) is reported; and 2)

$$( \frac{{p}_{1}}{{p}_{m}} , \frac{{p}_{2}}{{p}_{m}} , \frac{{p}_{3}}{{p}_{m}} , \frac{{p}_{5}}{{p}_{m}} , \frac{{p}_{6}}{{p}_{m}} , \frac{{p}_{7}}{{p}_{m}} , \frac{{p}_{8}}{{p}_{m}} )$$

is reported to the network (in that order), namely, (2/6, 0/6, 4/6, 1/6, −1/6, −3/6) is reported to the network. Note that because k=N=8, UE 801 does not need to explicitly report the selected PRS resource IDs anymore, since they can be implicitly derived by the network based on corresponding RSRPs that are reported in an increasing or decreasing order of the PRS resource IDs.

In a third embodiment (for this case k selected PRS resources are with contiguous PRS resource IDs), UE reports one of the k PRS resource IDs, say it is ID m (i.e., UE reports PRS resource ID m). UE may or may not report pₘ. UE reports the smallest PRS resource ID among the k selected PRS resource IDs. If the smallest PRS resource ID equals m, then this step may be skipped. UE reports RSRP ratios or differential RSRPs in an increasing order of PRS resource IDs, i.e., in the order of (xₐ, xₐ₊₁, . . . , xₐ₊ₖ₋₁), where a is the smallest PRS resource ID among the k selected PRS resource IDs, and

$${x}_{j} = \frac{{p}_{j}}{{p}_{m}}$$

or xⱼ=10 log pⱼ−10 log pₘ. This can be implemented by using transmission time order or data order in the data packet(s). Note that 1)

$$\frac{{p}_{j}}{{p}_{m}}$$

corresponds to RSRP ratio, where pⱼ,pₘ, are in linear scale, and 2) 10 log pⱼ−10 log pₘ corresponds to differential RSRP in dB scale. Under the third embodiment, suppose UE has selected k=4 PRS resources with ID 3, 4, 5, 6, and UE is going to report RSRPs measured from the selected k=4 PRS resources to the network. UE 801 may report the following information to the network: 1) PRS resource ID m=4 (with or without p₄)
is reported; and 2) a=3 and

$$( \frac{{p}_{3}}{{p}_{m}} , \frac{{p}_{5}}{{p}_{m}} , \frac{{p}_{6}}{{p}_{m}} )$$

is reported to the network (in that order), namely, a=3 and ( 2/6, 4/6, ⅙) is reported to the network. Note that because the selected PRS resources are with contiguous PRS resource IDs, only the smallest PRS resource ID among the selected PRS resources needs to be reported.

In a fourth embodiment (for this case k selected PRS resources are with contiguous PRS resource IDs), UE reports one of the k PRS resource IDs, say it is ID m (i.e., UE reports PRS resource ID m). UE may or may not report pₘ. UE reports the largest PRS resource ID among the k selected PRS resource IDs. If the largest PRS resource ID equals m, then this step may be skipped. UE reports RSRP ratios or differential RSRPs in a decreasing order of beam indices, i.e., in the order of (x_{b}, x_{b-1}, . . . , x_{b-k+1}), where b is the largest PRS resource ID among the k selected PRS resource IDs, and

$${x}_{j} = \frac{{p}_{j}}{{p}_{m}}$$

or xⱼ=10 log pⱼ−10 log pₘ. This can be implemented by using transmission time order or data order in the data packet(s). Note that 1)

$$\frac{{p}_{j}}{{p}_{m}}$$

corresponds to RSRP ratio, where pⱼ,pₘ are in linear scale, and 2) 10 log pⱼ−10 log pₘ corresponds to differential RSRP in dB scale. Under the fourth embodiment, suppose UE has selected k=4 PRS resources with ID 3, 4, 5, 6, and UE is going to report RSRPs measured from the selected k=4 PRS resources to the network. UE 801 may report the following information to the network: 1) PRS resource ID m=4 (with or without p₄) is reported; and 2) b=6 and

$$( \frac{{p}_{6}}{{p}_{m}} , \frac{{p}_{5}}{{p}_{m}} , \frac{{p}_{3}}{{p}_{m}} )$$

is reported to the network (in that order), namely, b=6 and (⅙, 4/6, 2/6) is reported to the network. Note that because the selected PRS resources are with contiguous PRS resource IDs, only the largest PRS resource ID among the selected PRS resources needs to be reported.

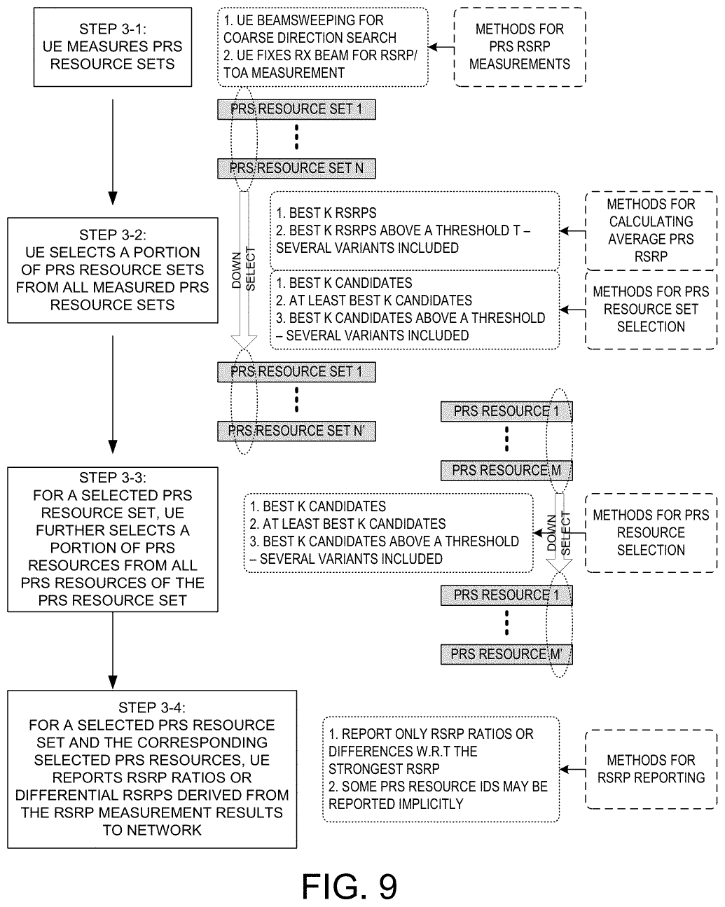

FIG. 9 illustrates a detailed procedure of UE performing measurements and reporting for DL-AoD positioning in accordance with one novel aspect. Suppose N PRS resource sets from different TRPs are configured for DL-AoD positioning for UE. Each TRP transmits PRS over the configured PRS resource sets. In step 3-1, UE measures the configured N PRS resource sets by performing beam sweeping for a coarse direction search, and then fixes RX beam for RSRP/TOA measurements. In step 3-2, UE determines the maximum or average PRS RSRP for each PRS resource set, and then down selects a portion of PRS resource sets based on the maximum or average PRS RSRP. In turns of calculating average PRS RSRP, the UE may 1) select the best k RSRPs, or 2) select the best k RSRPs above a threshold T, etc. In turns of selecting PRS resource sets, the UE may 1) select the best k candidates, 2) select at least the best k candidates, or 3) select the best k candidates above a threshold T, etc. After step 3-2, UE down selects N′ PRS resource sets from the N PRS resource sets.

In step 3-3, for a selected PRS resource set, UE down selects a portion of PRS resources from all PRS resources of the PRS resource set. The UE may 1) select the best k candidates, 2) select at least the best k candidates, or 3) select the best k candidates above a threshold T, etc. If one of the selected PRS resource set has M PRS resources, then after step 3-3, UE down selects M′ PRS resources from the M PRS resources. In step 3-4, for a selected PRS resource set and the corresponding selected PRS resources, UE reports RSRP ratios or differential RSRPs derived from the RSRP measurement results to the network. The UE may report only RSRP ratios or differential RSRPs with respect to the strongest RSRP, and some PRS resource IDs may be reported implicitly to reduce reporting overhead.

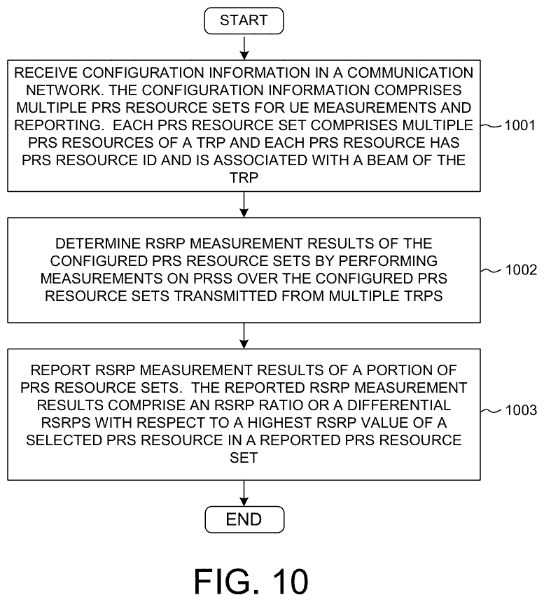

FIG. 10 is a flow chart of the method of RSRP reporting for DL-AoD positioning in accordance with one novel aspect. In step 1001, a UE receives configuration information in a communication network, wherein the configuration information comprises multiple positioning reference signal (PRS) resource sets for UE measurements and reporting. Each PRS resource set comprises multiple PRS resources of a transmission/reception point (TRP) and each PRS resource has a PRS resource ID and is associated with a beam of the TRP. In step 1002, the UE determines reference signal received power (RSRP) measurement results of the configured PRS resource sets by performing measurements on PRSs over the configured PRS resource sets transmitted from multiple TRPs. In step 1003, the UE reports RSRP measurement results of a portion of PRS resource sets. The reported RSRP measurement results comprise an RSRP ratio or a differential RSRP with respect to a highest RSRP value of a PRS resource in a reported PRS resource set.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving configuration information by a User Equipment (UE) in a communication network, wherein the configuration information comprises multiple positioning reference signal (PRS) resource sets for UE measurements and reporting, wherein each PRS resource set comprises multiple PRS resources of a transmission/reception point (TRP) and each PRS resource has a PRS resource ID and is associated with a beam of the TRP;
determining reference signal received power (RSRP) measurement results of the configured PRS resource sets by performing measurements on PRSs over the configured PRS resource sets transmitted from multiple TRPs; and
reporting RSRP measurement results of a portion of PRS resource sets, wherein the reported RSRP measurement results comprise an RSRP ratio or a differential RSRP with respect to a highest RSRP value of a PRS resource in a reported PRS resource set.

2. The method of claim 1, wherein the UE selects the portion of PRS resource sets from the configured PRS resource sets to report RSRP measurement results based on a maximum RSRP value or an average RSRP value of the corresponding PRS resource set.

3. The method of claim 1, wherein the reported PRS resource set has N PRS resources, and the UE reports the RSRP measurement results of k<=N PRS resources for the PRS resource set, and the RSRP measurement results further includes the highest RSRP value and a PRS resource ID having the highest RSRP value of the PRS resource in the reported PRS resource set.

4. The method of claim 3, wherein the UE also reports RSRP ratios or differential RSRP values with respect to the highest RSRP value, and PRS resource IDs for rest of (k−1) PRS resources in the reported PRS resource set.

5. The method of claim 3, wherein the UE also reports RSRP ratios or differential RSRP values with respect to the highest RSRP value for rest of (k−1) PRS resources in the reported PRS resource set in an increasing or decreasing order of the corresponding PRS resource IDs when k=N.

6. The method of claim 5, wherein the UE does not report PRS resource IDs for the rest of (k−1) PRS resources in the reported PRS resource set when k=N.

7. The method of claim 3, wherein the UE selects the k PRS resources from the N PRS resources of the reported PRS resource set to report RSRP measurement results based on RSRP values of the corresponding PRS resources in the reported PRS resource set.

8. A User Equipment (UE) comprising:
a receiver that receives configuration information in a communication network, wherein the configuration information comprises multiple positioning reference signal (PRS) resource sets for UE measurements and reporting, wherein each PRS resource set comprises multiple PRS resources of a transmission/reception point (TRP) and each PRS resource has a PRS resource ID and is associated with a beam of the TRP;
a measurement module that determines reference signal received power (RSRP) measurement results of the configured PRS resource sets by performing measurements on PRSs over the configured PRS resource sets transmitted from multiple TRPs; and
a transmitter that reports RSRP measurement results of a portion of PRS resource sets, wherein the reported RSRP measurement results comprise an RSRP ratio or a differential RSRP with respect to a highest RSRP value of a PRS resource in a reported PRS resource set.

9. The UE of claim 8, wherein the UE selects the portion of PRS resource sets from the configured PRS resource sets to report RSRP measurement results based on a maximum RSRP value or an average RSRP value of the corresponding PRS resource set.

10. The UE of claim 8, wherein the reported PRS resource set has N PRS resources, and the UE reports the RSRP measurement results of k<=N PRS resources for the PRS resource set, and the RSRP measurement results further includes the highest RSRP value and a PRS resource ID having the highest RSRP value of the PRS resource in the reported PRS resource set.

11. The UE of claim 10, wherein the UE also reports RSRP ratios or differential RSRP values with respect to the highest RSRP value, and PRS resource IDs for rest of (k−1) PRS resources in the reported PRS resource set.

12. The UE of claim 10, wherein the UE also reports RSRP ratios or differential RSRP values with respect to the highest RSRP value for rest of (k−1) PRS resources in the reported PRS resource set in an increasing or decreasing order of the corresponding PRS resource IDs when k=N.

13. The UE of claim 12, wherein the UE does not report PRS resource IDs for the rest of (k−1) PRS resources in the reported PRS resource set when k=N.

14. The UE of claim 10, wherein the UE selects the k PRS resources from the N PRS resources of the reported PRS resource set to report RSRP measurement results based on RSRP values of the corresponding PRS resources in the reported PRS resource set.
